(19) United States
(12) Patent Application Publication
(10) Pub. No.: US 2015/0012416 A1
(43) Pub. Date: Jan. 8, 2015

(54) SYSTEMS AND METHODS FOR SELECTING TRANSACTION CONDITIONS BASED ON ENVIRONMENTAL FACTORS

(71) Applicant: United Video Properties, Inc., Santa Clara, CA (US)

(72) Inventor: Thomas Steven Woods, Arlington Heights, IL (US)

(21) Appl. No.: 13/936,666

(22) Filed: Jul. 8, 2013

(51) Int. Cl. G06Q 20/38; G06Q 50/18

(52) U.S. Cl. CPC G06Q 20/38; G06Q 50/18
USPC 705/39

(57) ABSTRACT

Systems and methods for selecting transaction conditions based on environmental factors are discussed herein. In one embodiment, information indicating the current status of an environmental factor (e.g., the current weather, the current time of day) is received and used to select a transaction condition. The transaction condition includes a parameter that indicates under which circumstances access to a media asset is enabled (e.g., length of time during which access is permitted, the maximum number of user devices that may access the media asset). A display of a listing for the media asset is then generated. Additionally, an indication of the transaction condition is displayed. In response to a user selection of the displayed listing, access to the media asset is enabled under the circumstances indicated by the parameter of the transaction condition.

### BACKGROUND

Many transactions, including purchases, rentals, leases and licenses, are subject to transaction conditions. These conditions are often set forth in a contract governing the transaction that is also sometimes referred to as the transaction agreement. For example, if you rent a car in Europe, the transaction agreement might indicate that you are not allowed to drive the car to Italy. As another example, if you purchase a media asset (e.g., a digital song), the transaction agreement may set forth on how many user devices you are allowed to play it. These transaction agreements usually include standardized transaction conditions that are determined by a corporate entity engaged in the transaction based on business practices and that are used for all transactions of the same type.

### SUMMARY

In view of the foregoing, systems and methods for selecting transaction conditions based on environmental factors are provided.

In one embodiment, information indicating the current status of an environmental factor (e.g., the current weather, the current time of day) may be received and used to select a transaction condition. The transaction condition may include a parameter that indicates under which circumstances access to a media asset is enabled (e.g., length of time during which access is permitted, the maximum number of user devices that may access the media asset). A display of a listing for the media asset may be then generated. Additionally, an indication of the transaction condition may be displayed. In response to a user selection of the displayed listing, access to the media asset may be enabled under the circumstances indicated by the parameter of the transaction condition.

In one embodiment, the current status of the environmental factor may be the current weather, in which case a data structure that includes the current status may be received from a remote server that is associated with a weather service. In another embodiment, the current status of the environmental factor may be the current time of the day or the current day of the week, in which case a data structure that includes the current time of the day or the current day of the week may be retrieved from memory.

In one embodiment, user interactions may be monitored and used to generate a user profile. The transaction condition may then be selected based on this user profile.

In one embodiment, it may be determined whether the current status of the environmental factor matches a first status. If it does, the parameter of the transaction condition may be selected to indicate a first length of time during which access to the media asset is enabled. If the current status of the environmental factor does not match the first status, the parameter of the transaction condition may be selected to indicate a shorter second length of time during which access to the media asset is enabled. The current status of the environmental factor might be the current weather, in which case determining whether the current status matches the first status may involve determining whether the current weather includes one or more of rain, temperatures below a threshold, and humidity above another threshold. The current status might also be a current date, in which case determining whether the current status matches the first status may involve determining whether the current date corresponds to a workday.

In one embodiment, it may be determined whether the current status of the environmental factor matches a first status. If it does, the parameter of the transaction condition may be selected to indicate a first maximum number of devices from which the media asset can be accessed. If the current status of the environmental factor does not match the first status, the parameter of the transaction condition may be selected to indicate a smaller second maximum number of devices from which the media asset can be accessed.

In one embodiment, a user request to access the media asset may be received. It may then be determined, based on the parameter of the transaction condition, whether access to the media asset is enabled. If access is enabled, a display of the media asset may be generated. If access is not enabled, an indication that access to the media asset is not enabled may be displayed.

In one embodiment, a user request to display listings for media assets for which access is enabled may be received. It may then be determined, based on the parameter of the transaction condition, whether access to the media asset is enabled, and, if it is, a display of a listing for the media asset may be generated.

It should be noted that the systems and/or methods described above may be applied to, or used in combination with, other systems and/or methods as described below.

### BRIEF DESCRIPTION OF THE DRAWINGS

The above and other features of the present application, its nature and various advantages will become more apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments;

FIG. 3 shows an illustrative user equipment device in accordance with some embodiments;

FIG. 4 is a diagram of an illustrative cross-platform interactive media system in accordance with some embodiments;

FIGS. 5A and 5B show illustrative display screens that include advertisements for transactions that are subject to a transaction condition selected based on the current weather in accordance with some embodiments;

FIGS. 6A and 6B show illustrative display screens that include advertisements for transactions that are subject to a transaction condition selected based on the current day of the week in accordance with some embodiments;

FIGS. 7A and 7B show illustrative display screens that may be used to provide access to a media asset subject to a transaction condition selected based on a user profile in accordance with some embodiments;

FIG. 8 shows an illustrative display screen that includes listings for available and unavailable media assets that are subject to different transaction conditions in accordance with some embodiments;

FIG. 9 shows an illustrative display screen that may be displayed after a user attempts to access a media asset for which access is not enabled in accordance with some embodiments;

FIG. 10 is a flow chart of a process for selecting a transaction condition based on an environmental factor and for enabling access to a media asset in accordance with some embodiments; and

FIG. 11 is a flow chart of a process for attempting to access a media asset that is subject to a transaction condition in accordance with some embodiments.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

Receiving media assets may involve a number of different transactions. For example, media assets may be purchased, rented or available free of charge. Sometimes, the same media asset may be available using multiple different transactions. The same media asset might thus be rented or purchased, potentially at different prices. Alternatively or in combination, a transaction may involve providing access to media assets only to users that subscribe to a particular service. Each of these transactions may be subject to transaction conditions, which place limitations on a user's right to consume the media to which access is obtained in the transaction. Generally, transaction conditions can be defined using two elements—a type of transaction condition (e.g., access is limited in time, access is limited by number of user devices, access is limited in number of accesses, access is limited by types of user equipment devices, and/or access is limited by access manner) and an accompanying parameter (e.g., length of time for which access is enabled, number of user devices for which access is enabled, number of accesses for which access is enabled, types of user devices for which access is enabled and/or access manners for which access is enabled). Examples of transaction conditions may include for how long access to a media asset is available (e.g., a media asset may be rented for a specific number of days), how often a media asset may be accessed (e.g., a media asset may only be watched a specific number of times), from how many user devices a media asset may be accessed (e.g., a media asset may only be accessed from user devices that are connected to a single local network, a media asset may only be accessed from a single user device or a specified number of user devices, and/or a media asset may only be accessed from one user device at a time), from what types of user devices a media asset may be accessed (e.g., a media asset is available only to stationary, as opposed to mobile, user devices), over what types of networks a media asset may be accessed (e.g., a media asset may be only available over a cable service and/or over an Internet connection), how many users may access the media asset (e.g., a maximum number of user profiles that may be authorized to access the media asset) and in which manner a media asset may be accessed (e.g., whether a media asset may be locally stored, whether a media asset may only be streamed and/or whether accessing a media asset requires an active Internet connection). Accordingly, these transaction conditions indicate circumstances under which a media asset may be accessed (e.g., within a length of time after the transaction, only if the number of accesses is less than a specified number of times, only from user devices that have been authorized or that are of a specific type and/or only if the media asset is accessed in a specific manner).

Selecting transaction conditions may involve striking a balance between conflicting factors. Having generous transaction conditions (e.g., long rental periods, not limiting the number of user devices that may access the media asset) for a transaction may encourage users to engage in this transaction. However, generous transaction conditions may also lower the profitability of a transaction to the content provider (e.g., because the content provider has to pay higher royalties), discourage users from engaging in more profitable transactions (e.g., if a user can rent a media asset for a long period of time, there might not be any incentives for the user to instead purchase the media asset), decrease the total number of transactions (e.g., a user might rent the same media asset from multiple user devices if a transaction condition allows access to the media asset from only a single user device) and encourage abuse (e.g., allowing access to a media asset from multiple user devices may result in multiple users sharing an account and thus accessing the media asset without paying).

A content provider may weigh any of these factors to select a transaction condition. As one example, transaction conditions may be set in an attempt to maximize profits for any given transaction. This may involve using the strictest transaction conditions (e.g., short rental period, media asset can only be accessed from a single user device), thereby potentially minimizing royalty payments due or maximizing the likelihood that more transactions will occur, that will still entice a user to engage in the transaction. As another example, transaction conditions may be set in an attempt to maximize the user experience while still producing a particular profit (e.g., the content provider still breaks even). This may involve selecting a generous parameter for a transaction condition of a type the user cares about (e.g., a busy user really cares about a long rental period) and a stricter parameter for transaction condition that is not important to the user (e.g., a user with a single user device presumably does not care about the ability to access the media asset from multiple user device).

With the advent of the Internet, mobile computing, and high-speed wireless networks, users are accessing media and engaging in transactions on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. Additionally, media guidance data may include data related to a transaction a user must engage in to gain access to a media asset. Media guidance data may thus include information identifying the type of a transaction (e.g., rental or purchase of a media asset), a price of the transaction, information that enables the transaction to be performed (e.g., network addresses from which a media asset may be downloaded or a protocol to be employed) and accompanying transaction conditions. The transaction conditions may, in turn, be defined using one or more data structures that can be processed by the media guidance application in order to determine under which circumstances access to a media asset is enabled (e.g., in order to calculate for how many more days a rented media asset is accessible) and/or to determine whether access to a media asset is enabled under current circumstances (e.g., in order to determine whether a media asset can be accessed from the current user device). These data structures of the media guidance data may include one or more of a pointer or other data identifying one or more associated media assets, a flag or other data identifying a type of transaction condition (e.g., limiting access to a number of user devices, limiting access to a length of time, limiting access to a number of accesses) and a value or other data identifying the accompanying parameter (e.g., the number of user devices, length or time or number of accesses).

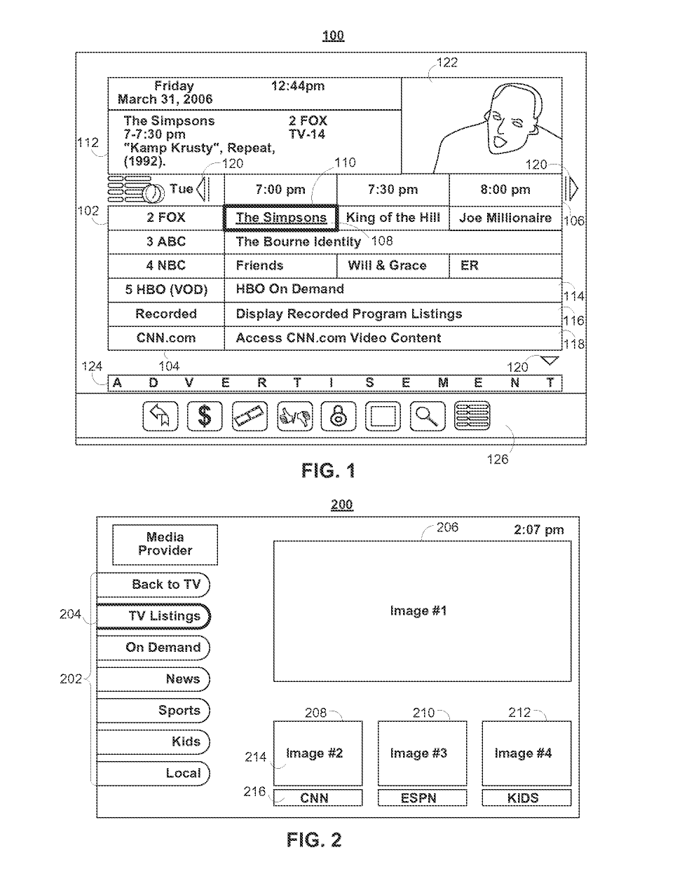

FIGS. 1-2 show illustrative display screens that may be used to provide media guidance data. The display screens shown in FIGS. 1-2 and 5-9 may be implemented on any suitable user equipment device or platform. While the displays of FIGS. 1-2 and 5-9 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP). Accessing any of the non-linear programming may involve engaging in a transaction that may be subject to one or more transaction conditions.

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming) and the current circumstances (e.g., the type of device used to generate display 100), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. In response to a user selection of advertisement 124, the media guidance application may automatically, or following a number of additional steps, perform a transaction advertised by advertisement 124. For example, the media guidance application may order an advertised product or purchase and download an advertised media asset in response to a user selection of advertisement 124. Advertisement 124 may be targeted based on a user profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.), media assets advertised in advertisement 124 or presented in grid 102 (e.g., listings 114-118 for non-linear programming may be for media assets that are targeted based on the user profile) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

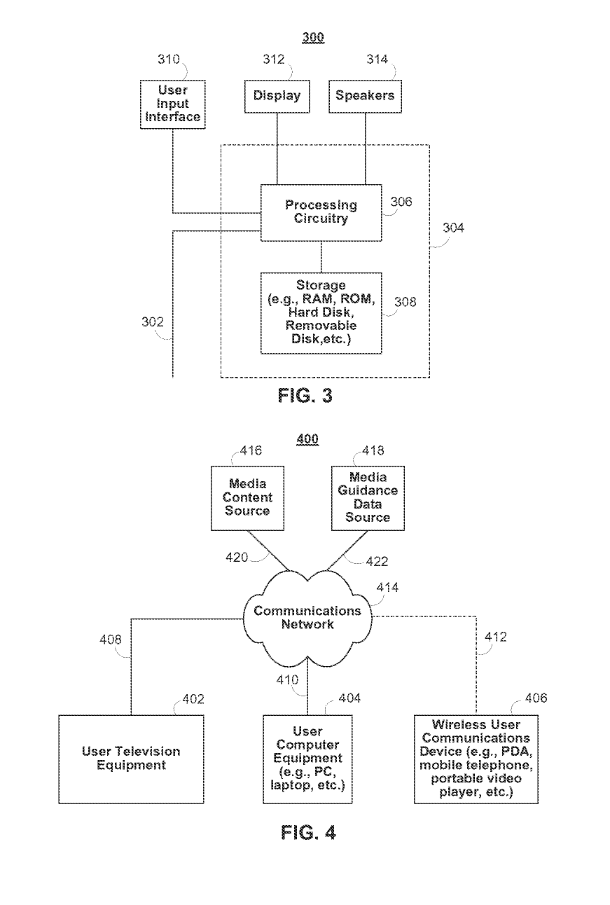

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. User television equipment 402, user computer equipment 404 and wireless user communications device 406 may thus be considered one or more different types of user equipment devices. The distinction between different types of user devices may be based on the mobility of user devices (e.g., stationary user devices, such as user television equipment 402, might be considered a first type of user equipment device, while mobile user devices, such as wireless user communications device 406, may be considered a different second type of user equipment device), their UI capabilities (e.g., the resolution display 312 and/or the type of user input interface 310 of each user device) and the types of communication paths accessible at each user device. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406. The type of user equipment device a user device is considered may also dictate which media assets are available to the user device and/or the quality of the media content transmitted to or displayed on each user device (e.g., an SD or HD video). Additionally, transactions may be subject to transaction conditions that limit which types of user equipment devices may be used to access a media asset.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Each of user television equipment 402, user computer equipment 404 and wireless user communications device 406 may be associated with a unique network address and/or other identifier. This network address and/or other identifier may enable media content source 416 and/or media guidance data source 418 to identify the user device and/or type of user equipment device that transmitted received data and/or requests, such as a request to access a media asset.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

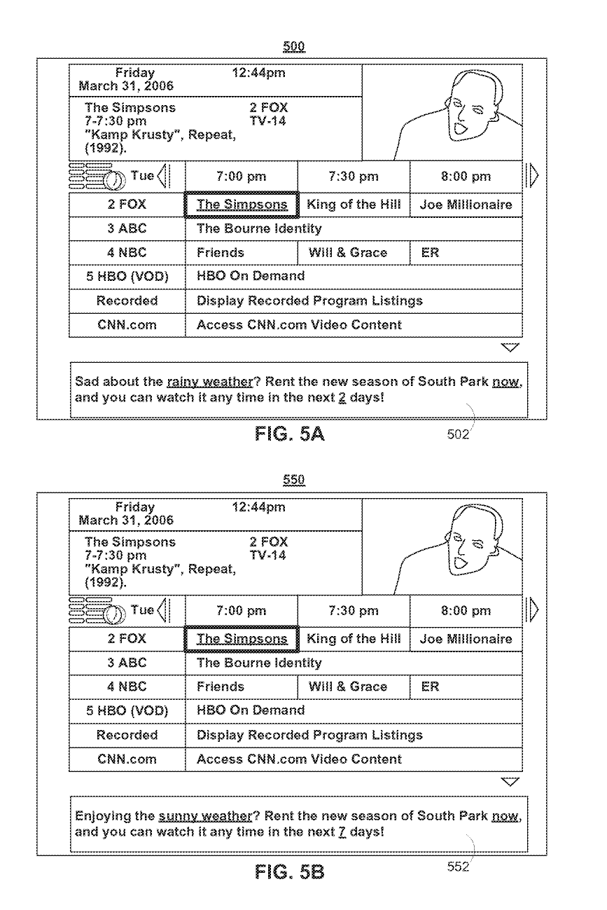

FIG. 5A shows illustrative display screen 500, which may be presented on display 312 of user device 300. Display screen 500 is generally similar to display 100 and may include any of the features and functionalities described above in reference to display 100. Display screen 500 may also include advertisement 502, which may be similar to advertisement 124 and may include any of the features and functionalities described above in reference to advertisement 124.

Advertisement 502 is illustrated as advertising a media asset available for rent. As shown, the transaction of renting the advertised media asset is subject to a transaction condition—in this case, engaging in the transaction provides access to the media asset for two days. The type of transaction condition (the rental is for only a limited time) and/or the accompanying parameter (the time limit is 2 days) may have been selected based on any of the conflicting factors discussed above. Alternatively or in combination, the media guidance application or a content provider may consider environmental factors when selecting one or more transaction conditions. Examples of environmental factors may include any combination of one or more of time (e.g., the current time of the day, the current day of the week and/or the current season of the year), weather (e.g., the current temperature, humidity, wind speed and/or presence or absence of any weather characteristic such as rain, snow, hail, sunshine and/or clouds), air quality, current events (e.g., the recent occurrence of a natural disaster, accident, emergency and/or other type of breaking news), the immediate environment (e.g., the temperature of the user equipment device or its immediate surrounding), location (e.g., whether the user device is near the user's home), connection type or strength (e.g., whether some media services are experiencing a service outage, and/or the strength of a connection over which media assets may be accessed), and/or the size or makeup of the audience (e.g., the number of users interacting with the media guidance application, the marital status of the audience and/or whether the members of the audience were recently involved in an accident and/or are injured).

The current status of an environmental factor may be received from a number of sources. User device 300 may be able to determine some of these environmental factors using local sensors, may receive the information completely independent of any process for selecting transaction conditions, may receive this information periodically or in response to certain events, may store this information in storage 308 and/or may retrieve the information from one or more of media content source 416, media guidance data source 418 or a third party server (e.g., the media guidance application may retrieve information regarding the current weather from a server associated with a weather service, and/or the media guidance application may retrieve information regarding current events from a server associated with a news service). The current status of an environmental factor may be part of a data structure (e.g., an IP packet received over communications network 414) or may be determined by reading local registers (e.g., a register associated with a hardware sensor of user device 300).

As illustrated by advertisement 502, the media guidance application may determine that it is currently raining and, based on this information, select a short length of time (2 days) during which media asset can be accessed. Since it is raining, and the user therefore has fewer activities he or she can engage in, a user might be more likely to engage in this transaction even though the transaction condition is not particularly generous. The media guidance application may leverage this by offering a transaction with stricter transaction conditions. This may be in order to maximize profits or in order to improve the overall desirability of offer to a user while maintaining profits (e.g., by making other transaction conditions more generous and/or by lower the price of the transaction).

FIG. 5B shows illustrative program listings display screen 550 which includes advertisement 552. Display screen 550 may correspond to display screen 500, and advertisement 552 may correspond to advertisement 550. As illustrated, advertisement 552 may advertise the same media asset as advertisement 502, but offer the media asset subject to a different transaction condition than advertisement 502 (e.g., renting the media asset enables access to it for 5 days instead of only 2). In particular, advertisement 552 may include a parameter of the transaction condition (illustrated as the length of time of the rental) different than advertisement 502. This might be because the transaction condition of advertisement 502 was selected based on one current status of an environmental factor (it is raining), whereas the transaction condition of advertisement 552 was selected based on a different current status of the same environmental factor (it is sunny). When generating advertisement 552, the media guidance application may have determined, based on the current weather, that a more favorable transaction condition was necessary to entice the user to engage in the transaction than when generating advertisement 502.

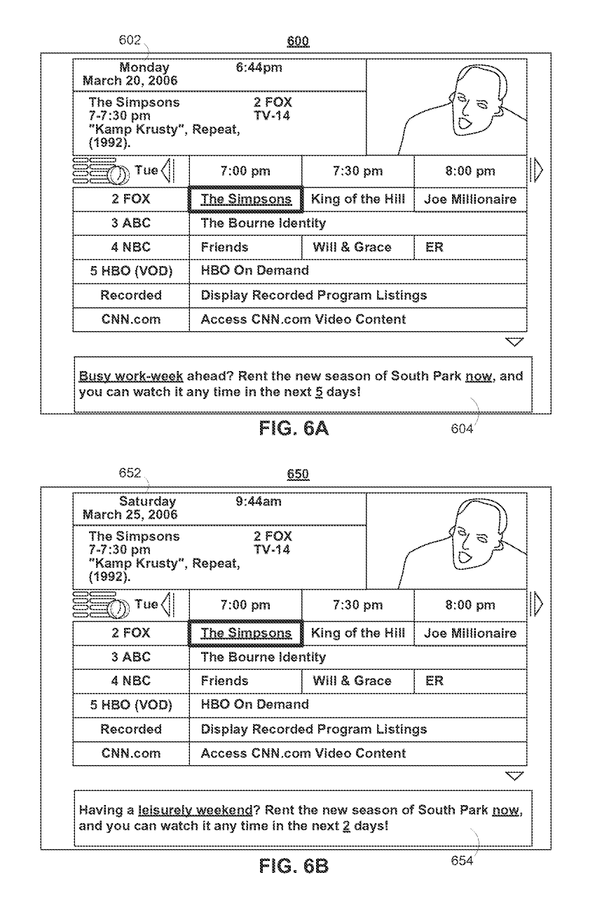

FIG. 6A shows illustrative display screen 600, which is generated at time 602 and includes advertisement 604. Similar to advertisement 502, advertisement 604 may also advertise a transaction involving a media asset that is subject to a transaction condition. Additionally, the transaction condition of advertisement 604 may also have been selected based on an environmental factor. However, whereas the transaction condition of advertisement 502 was selected based on the current weather, the transaction condition of advertisement 604 is selected based on current time 602. In this example, the media guidance application may determine that it is a workday and that a user is thus unlikely to have a lot of time available for consuming media content. In order to entice the user to engage in the advertised transaction, the media guidance application may determine that a more generous transaction condition is necessary, and accordingly select a more generous parameter for the transaction condition (e.g., renting the media asset grants access to the media asset for 5 days).

FIG. 6B shows illustrative display screen 650, which is generated at time 652 and includes advertisement 654. Similar to advertisement 604, advertisement 604 may also include a transaction condition that is selected based on the current time. However, since the current time 652 is different from current time 602, a parameter of the transaction condition of advertisement 654 may be different from a corresponding parameter of the transaction condition of advertisement 604. For example, since advertisement 654 is generated on a non-workday (e.g., over the weekend), the media guidance application may determine that the user has more time available for consuming media content and accordingly offer less favorable transaction conditions.

While FIGS. 5A, 5B, 6A and 6B are discussed as selecting a parameter of the transaction condition based on the current status of an environmental factor, this need not be the case. The media guidance application may select any parameter of a transaction condition, any type of the transaction condition or any combination thereof discussed in this application based on any environmental factor discussed in this application. The media guidance application may, in addition or alternatively, consider one or more environmental factors when deciding whether to generate a display of an advertisement, which media asset to advertise, what the price is or any other characteristic of the advertised transaction. Additionally, while this application mostly discusses selecting transaction conditions and/or other characteristics of a transaction for obtaining access to a media asset based on environmental factors, environmental factors also may be used to select transaction conditions and/or other characteristics of a transaction for obtaining any product, good and/or service

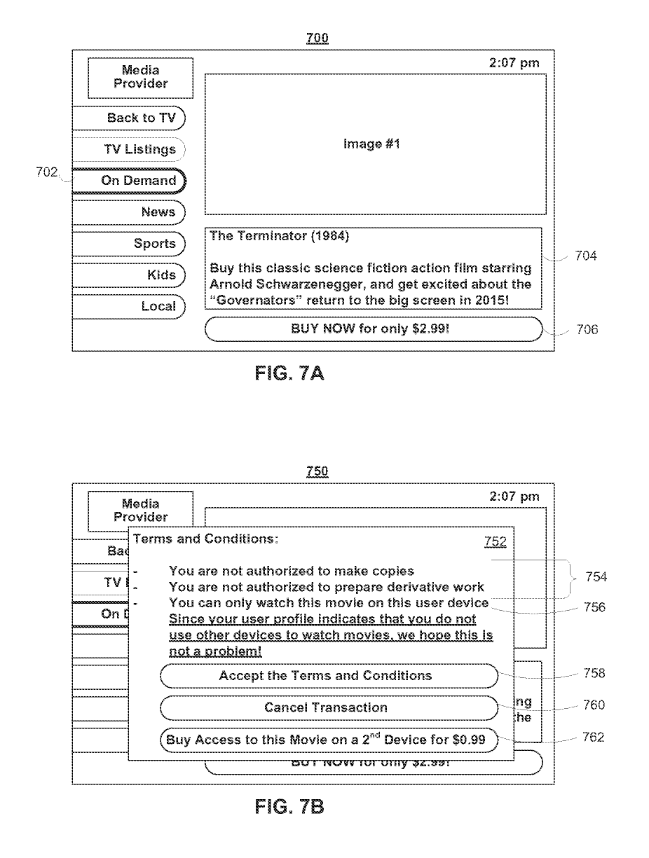

FIG. 7A illustrates display screen 700. Display screen 700 may be generated for display by the media guidance application in response to a series of user selections for browsing media assets available under on demand option 702. The media asset described by area 704 of the displayed listing may thus have been searched for and selected by the user. Alternatively, display screen 700 may also be displayed in response to a user selection of advertisement 124. Display screen 700 includes option 706 for purchasing the media asset described in area 704.

In response to a user selection of option 706 of display screen 700, the media guidance application may cause display screen 750 of FIG. 7B to be displayed. Display screen 750 may consist of display screen 700 that has been overlaid by the media guidance application to include overlay 752. Overlay 752 includes the transaction agreement for the transaction advertised by option 705. Overlay 752, in turn, may include transaction condition 754-756 and selectable options 758-762. Alternatively, overlay 752 may be displayed as an overlay over display 100 in response to a user selection of advertisement 124.

Any of transaction conditions 754-756 may be either selected based on an environmental factor or may be a default transaction condition that is part of every transaction agreement. Additionally or alternatively, any of these transaction conditions may be selected based on a user profile. In this example, transaction conditions 754 are default transaction conditions that may be included in all transactions or a subset of transactions (e.g., all transactions occurring in the United States).

Transaction condition 756, on the other hand, is illustrated as being selected based on a user profile. The media guidance application may select a transaction condition based on a variety of user profile information. For example, a transaction condition may be generated based on the user's viewing habits (e.g., including shorter rental terms for users that consume media content for extend periods of time in one sitting, including a lower number of user devices that may be authorized to access the media content if the user always consumes media content using the same user device), user preferences (e.g., including higher number of available viewings if an advertised media asset is closely aligned with the user preferences), manually entered user information (e.g., allowing access to the media asset from only a single user device if the user profile is associated with only one device) and a user budget (e.g., including stricter transaction conditions in order to drive down the price of the transaction if the user budget is low on funds, including more generous transaction conditions in order to increase price and profitability if the user budget is high on funds).

The media guidance application may use a combination of environmental factors and the user profile when selecting transaction conditions for a transaction. For example, the user profile may include information regarding how many hours a user generally consumes media content during different times of the day and/or different days of the week. The media guidance application may then select a rental period with the minimum length of time that still allows the user to comfortably consume the media asset within the time the user generally spends consuming media content during the current time of the day and/or day of the week. Similarly, the media guidance application may determine the user's viewing habits during different weather conditions, and use this information to extend the rental period if the user profile indicates that the user does not spend a lot of time consuming media content when weather conditions are similar to the current weather conditions.

In response to a user selection of option 758, the media guidance application may perform a transaction to grant access to the media asset subject to the transaction conditions (e.g., transaction conditions 754-756). Performing a transaction may involve storing a transaction data structure that include an identifier of the type of transaction that was performed (e.g., rental or purchase), one or more data structures identifying the agreed to transaction conditions, an identifier of the media asset, identifiers of the one or more user profiles and/or user devices that have been granted access to the media asset, an identifier of media content source 416 from which the media asset is available and/or a flag that indicates whether the media content may still be accessed. This transaction data structure may be stored in storage 308, storage of media content source 416 and/or storage of media guidance data source 418. The transaction data structure may be indexed by user profile and/or user device (e.g., the data may be stored in a user profile that indicates all media assets that may be accessed by a user and/or user device) or by media asset (e.g., the data may be stored in a media asset profile that indicates all users and/or user devices that may access the media asset). Performing the transaction may additionally involve updating a budget of a user profile and/or communicating with a server associated with a financial institution in order to charge the user for the transaction.

In response to a user selection of option 760, the media guidance application may remove overlay 752 and thus return to display screen 700 or any other display screen. Since a selection of option 760 may indicate that this transaction will not be performed at this time, the media guidance application may additionally delete any data that was temporarily stored in anticipation of performing the advertised transaction (e.g., any elements of the transaction data structure that the media guidance application prepared in anticipation of completing the transaction).

In response to a user selection of option 762, the media guidance application may modify one or more transaction conditions. In this example, the media guidance application may modify transaction condition 756 to indicate that two user devices may be authorized to access the media asset. Transaction conditions that a user does not agree with may thus be modified. The modification may cost an additional surcharge (e.g., $0.99) that is added to the price of the transaction or charged as a separate transaction. This surcharge may reflect the additional cost in royalties that allowing access to the media asset from a second device would cost the content provider. Alternatively or in combination, the media guidance application may display options for modifying a transaction condition, such as option 762, even after a transaction has been performed. For example, the media guidance application may display option 762 in response to a user request to access the media asset on a second user device. Instead of modifying a transaction condition of a present transaction, the media guidance application may perform an altogether different transaction in response to a user selection of option 762. For example, option 762 may allow a user to purchase a media asset instead of renting it if he or she is not satisfied with a transaction condition (e.g., the rental period). Finally, while option 762 is illustrated as a selectable option, option 762 may also be a text box that allows for input of a custom parameter of a transaction condition, multiple options that correspond to different parameters and/or multiple options that correspond to different types of transaction conditions.

While transaction conditions 754-756 have been described as being selected by the media guidance application, these transaction conditions may also be selected by a processor of media content source 416. For example, the media guidance application may display listings for media assets available from media content source 416 via one or more transactions. In response to a user selection of one of these listings, the media guidance application may transmit a request for the corresponding media asset to media content source 416 and, in response, receive one or more data structures that indicate transaction conditions. Alternatively, assembling information regarding media assets available from media content source 416 in order to generate media guidance data may involve receiving data structures that indicate accompanying transaction conditions. Accordingly, transaction conditions may be selected by media content source 416 using any of the approaches discussed herein, and data structures indicating these transaction conditions may then be received by either user device 300 or media guidance data source 418. Additionally, multiple potential parameters and/or types of transaction conditions (potentially alongside other features of a transaction, such as price) may be received by either user device 300 or media guidance data source 418, and the media guidance application may then select amongst these potential parameters and/or types of transaction conditions based on environmental factors and/or a user profile.

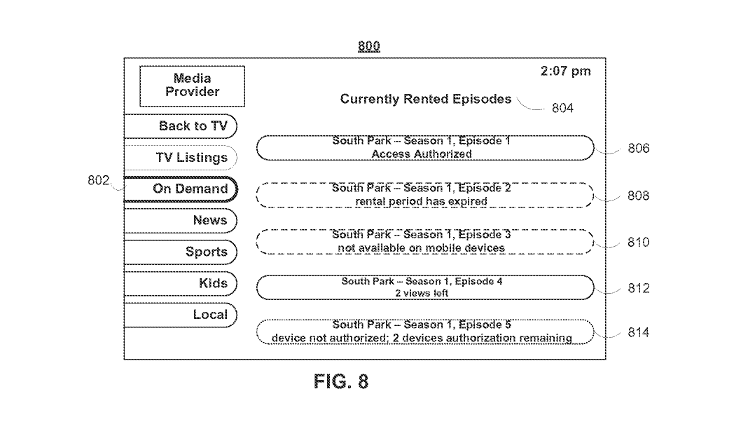

FIG. 8 shows illustrative display screen 800. Listings 806-814 may correspond to media assets that belong to category 804. The media guidance application may generate a display of display screen 800 in response to a user selection of option 802, potentially followed by additional user input in order to navigate to category 804.

Access to the media assets corresponding to listings 806-814 may have been obtained through a single transaction, through multiple simultaneous transactions or through multiple transactions that occurred in response to separate user selections of media assets and/or at separate times. While these media assets are illustrated as all being obtained through rental transactions, display screen 800 may alternatively include listings for media assets to which access was obtained through a variety of transaction types, such as rentals, purchases and licenses.

Listings 806-814 may indicate whether each of the corresponding media assets can be accessed under the current circumstances (e.g., at the current time and from the current user device). In this example, access to listings 806 and 812 is enabled. Listings might not include an indication of applicable transaction conditions, whether or not such transaction conditions exist. For example, listing 806 indicates that the media asset can be accessed without providing any additional information regarding relevant transaction conditions. Listings might include an indication of an applicable transaction condition if one exists. For example, listing 812 is displayed with solid border, thereby indicating that the media asset can be accessed, and also includes an indication that the media asset can only be accessed two more times.

Listings may also indicate that access to a media asset was previously obtained through a transaction, but that the corresponding media asset cannot be currently accessed from the current user device because the circumstances of a transaction condition are not met. For example, listing 808 has a dashed border, thereby indicating that the media asset is not available and/or that the listing cannot be selected, and that the media asset cannot be accessed because the rental period has expired. In response to a user selection of listing 808, the media guidance application may not perform any function (e.g., listing 808 is not selectable), may cause an error or warning message to be displayed and/or may cause option 762 for modifying the transaction condition that prevents access to the media asset to be displayed. Alternatively, option 762 may be displayed instead of listing 808 or adjacent to listing 808. Listing 810 also indicates that the media asset is not available and indicates the transaction condition that prevents access to the media asset. However, unlike the media asset corresponding to listing 808 which is no longer available from any user device due to the expiration of the rental period, the media asset corresponding to listing 810 might be inaccessible only from the current device. Since the transaction condition associated with listing 810 indicates that the media asset is not available on mobile devices, if display screen 800 is displayed on a display of wireless user communications device 406, listing 810 may indicate that the corresponding media asset is not available. However, if display screen 800 is displayed on a display of user television equipment 402, listing 810 may indicate that the corresponding media asset is in fact available. Instead of displaying listings 808 and 810 for media assets that are not currently available, the media guidance application may also omit these listings and display only listings for media assets that are currently available.

Listing 814 may be for a media asset that is not currently accessible, but that may become accessible in response to additional user selections. This may be indicated by the fact that the border of listing 814 is dotted or through another indication. As illustrated by listing 814, a transaction condition may specify that a media asset is available from only a limited number of user devices and/or user profiles. The media guidance application may make the media asset accessible in response to a user selection of listing 814, in response to additional user selections indicating a desire to authorize the current device and/or the current user profile to access the media asset, in response to user input of a particular code associated with the media asset and/or content provider or in response to user input modifying a user profile in order to authorize access. Authorizing access may involve modifying the transaction data structure that was generated in connection with performing the transaction to obtain access to the media asset in order to add an identifier of the current user device and/or user profile or another user device and/or user profile specified via user input. As another example, if a transaction condition indicates that a media asset is accessible for only a specific period of time after the media asset is initially accessed, providing authorization may involve storing an access start time in the transaction data structure, and the transaction data structure may then be used to determine if the period of time following this initial access start time has expired. Following this additional selection, the media asset corresponding to listing 814 may become accessible from the current user device and/or another user device specified via user input and/or displayed listing 814 may be modified to indicate that the corresponding media asset is accessible (e.g., the dotted border of listing 814 may be displayed as a solid line).

The media guidance application may determine the availability of each of the media assets corresponding to listings 806-814 in response to a user request to view display screen 800 by either determining whether current circumstances match the circumstances under which the transaction conditions stored in the transaction data structure for the media asset indicate the media asset is available and/or by retrieving the flag stored in the transaction data structure that indicates the current availability of the media asset. The flags of the transaction data structures may, in turn, be updated periodically (e.g., every day media assets obtained in rental transactions for which the rental period ended on that date are updated to reflect that they are no longer available), in response to a user selection (e.g., in response to a user request to access display screen 800, the media guidance application may first confirm that any media assets flagged as still available or previously displayed as available are, in fact, still available and update their flags accordingly), or in response to any other event.

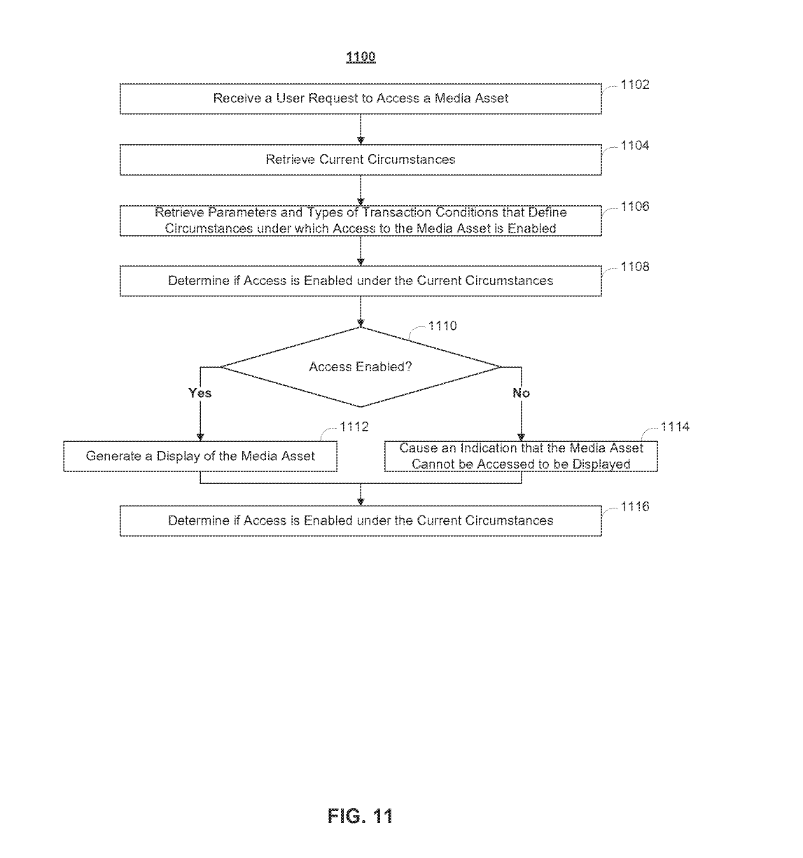

The media guidance application may determine whether each media asset represented by listings 806-814 is available using one or more of the steps of process 1100 described below with reference to FIG. 11.

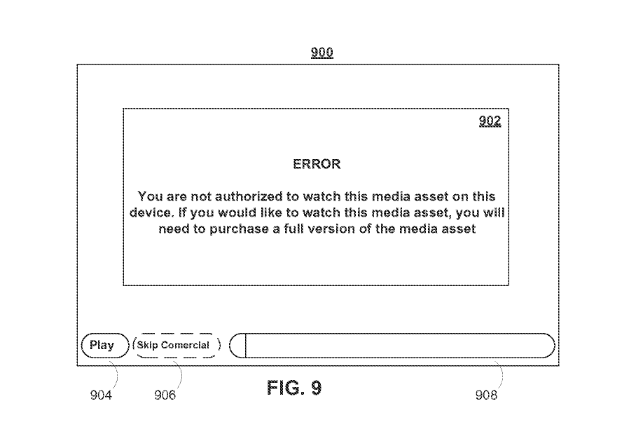

FIG. 9 illustrates display screen 900, which may be used to display a selected media asset. For example, in response to a user selection of any one of listings 806-814, the media guidance application may generate display screen 900 for displaying the corresponding media asset. The media guidance application may additionally determine whether a media asset is currently accessible and, if not, cause overlay 902 to be displayed. If the media asset is currently accessible, the media guidance application may instead display options 904-906 and time indicator 908 and/or render these options 904-906 and time indicator 908 selectable.

Overlay 902 may indicate the transaction condition that was not met and thereby indicate why the selected media asset might not be accessible. This may be instead of or in addition to indicating the accessibility of each media asset via corresponding listings 806-814. Additionally, the media guidance application may determine whether access to the media asset is enabled before receiving a user selection of the media asset or only in response to the user selection. Overlay 902 may also include selectable options for returning to the previous display screen (e.g., display screen 800), for modifying the transaction condition of the transaction that provided access to the media asset (e.g., paying a surcharge in order to allow the media asset to be displayed on additional devices) and/or for engaging in another transaction for the media asset (e.g., purchase a copy of the media asset after previously renting it or perform another rental transaction in order to restart the rental period during which the media asset may be accessed).

The methods and systems described in this application are also applicable to selecting or modifying other aspects of a transaction. For example, option 906 might not be selectable, as indicated by the dashed border, because the performed transaction only granted access to a version of the media asset in which commercials cannot be skipped. Accordingly, the media guidance application may select the version of a media asset (e.g., HD vs. SD, with or without additional features, with or without trick play options enabled) to which access is granted in a transaction based on environmental factors and/or a user profile.

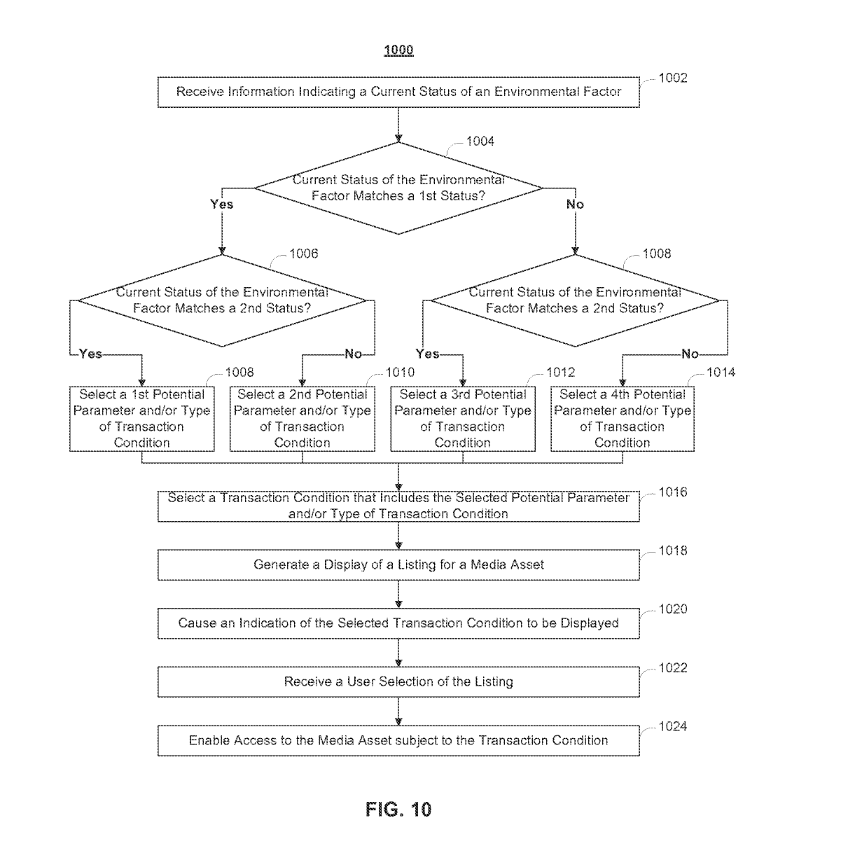

FIG. 10 illustrates process 1000 for selecting transaction conditions for a transaction associated with a media asset and for enabling access to the media asset.

At step 1002, the media guidance application may receive information indicating a current status of an environmental factor. As discussed in further detail above, this may involve reading a register and/or retrieving a data structure for the environmental factor from one or more of a remote server (e.g., media content source 416 of FIG. 4 and media guidance data source 418 of FIG. 4) and storage 308 of FIG. 3.

At step 1004, the media guidance application may determine whether the current status of the environmental factor matches a first status. The first status may be determined based on information identifying the first status. This information may be received as part of the guidance application data, may be received as media guidance data and/or may be retrieved from either media content source 416 of FIG. 4 or media guidance application source 418 of FIG. 4. The information identifying the first status may be specific to a particular media asset (e.g., a given movie), a type of media asset (e.g., episodes of any television series), media assets provided by a particular content provider (e.g., all media assets available from media content source 416 of FIG. 4), media assets available via a particular type of transaction (e.g., media assets available for rent) and/or all media assets. The information identifying the first status may be received together with information identifying the environmental factor against which it is to be compared (e.g., a single data structure includes both information identifying the first status and information identifying the environmental factor against which it is to be compared), received separately from information identifying the environmental factor against which it is to be compared but received from the same source (e.g., both the information identifying the first status and the information identifying the environmental factor against which it is to be compared may be received from media content source 416 of FIG. 4) or received from a different source than information identifying the environmental factor against which it is to be compared (e.g., information identifying the first status may be retrieved from media content source 416 of FIG. 4, while information identifying the environmental factor against which it is to be compared may be received as guidance application data).

The media guidance application may determine whether the current status of an environmental factor matches the first status by determining if the current status falls within a range of values specified by the information identifying first status (e.g., whether the current temperature is below a threshold specified by the first status), whether the current status falls within a set of statuses described by the information identifying the first status (e.g., whether the current day is a non-workday) and/or whether the current status is one of a list of statuses listed by the information identifying the first status (e.g., whether the current weather includes at least one of rain, snow and hail). The first status may be any possible status, set of statuses and/or list of statuses of any of the environmental factors discussed above.

While step 1004 has been described as involving a direct comparison between the current status of an environmental factor and a first status, the determination may also be more indirect. The media guidance application may thus compare information derived from the current status with other types of information besides information identifying a first status. For example, the media guidance application may determine, based on the current status (e.g., day of the week), how much time a user is likely to be willing to commit to consuming media, and compare this amount of time against a first amount of time instead of the first status. Information identifying the first amount of time may be received in the same manner as the information identifying the first status.

Additionally or alternatively, the first status (or, in the example above, the first amount of time) may also be determined based on the characteristics of a media asset. Referring back to the example above, instead of receiving information identifying the first amount of time in the same manner as the information identifying the first status, the first amount of time may be selected to be the length of the media asset. Accordingly, the media guidance application may determine whether it is likely that a user has sufficient time to consume the media asset in one sitting and select a transaction condition accordingly. For example, the media guidance application may set a transaction condition to specify a rental period of a single day or to specify that the media asset may only be accessed once if media guidance application determines at step 1004 that the user is likely to have sufficient time to consume the media asset in a single sitting.

The media guidance application may consider a user profile when deriving information from the current status of the environmental factor. For example, the user profile may indicate how much time a user generally spends consuming media content at different times of the day or under different weather conditions. This information may then be compared to the first amount of time as discussed above. Similarly, the first amount of time (or any other information used in step 1004) may be derived from the first status alone or in combination with one or more of a user profile and characteristics of a media asset. Performing step 1004 may thus involve any combination of one or more of the current status of the environmental condition, a user profile, characteristics of a media asset and/or information identifying a first status.

If the media guidance application determines at step 1004 that the current status of the environmental factor matches a first status, the media guidance application may next determine whether the current status of the environmental factor also matches a second status at step 1006. Information identifying the second status may be stored together with the information identifying the first status (e.g., a single data structure includes both the first status and the second status), stored separately from the information identifying the first status but be received from the same source (e.g., both the information identifying the first status and the information identifying the second status may be received from media content source 416 of FIG. 4) or received from a different source than the information identifying the first status (e.g., information identifying the first status may be retrieved from media content source 416 of FIG. 4, while information identifying the second status may be received as guidance application data). The information identifying the first status may also include a pointer to information identifying the second status for use only if the current status matches the first status, only if the current status does not match the first status or regardless of the result of the determination performed at step 1004. The second status may be of the same type as the first status (e.g., the first status may be a first temperature threshold, while the second status may be a second temperature threshold), may be of different types but associated with the same or related environmental factors (e.g., the first status may be a temperature threshold, while the second status may be the presence of rain) or may involve altogether different environmental factors (e.g., the media guidance application may consider the current time of the day at step 1004 and the current weather at step 1006). The second status may be any possible status, set of statuses and/or list of statuses of any of the environmental factors discussed above.

If the media guidance application determines at step 1006 that the current status of the environmental factor also matches the second status, the media guidance application may select a first potential parameter and/or type of transaction condition at step 1008. In particular, the media guidance application may have a number of potential parameters and/or types of transaction conditions to choose from and may select one or more of these based on the result of the determinations performed at steps 1004-1008. These potential parameters and/or types of transaction conditions may be part of the guidance application data, may be received as media guidance data, may be received from either media content source 416 of FIG. 4 or media guidance application source 418 of FIG. 4 and/or may be calculated based on the current status of the environmental factor. These potential parameters and/or types of transaction conditions may be specific to a particular media asset (e.g., a given movie), a type of media asset (e.g., episodes of any television series), media assets provided by a particular content provider (e.g., all media assets available from media content source 416 of FIG. 4), media assets available via a particular type of transaction (e.g., media assets available for rent) and/or all media assets.

If the media guidance application determines at step 1006 that the current status of the environmental factor does not also match the second status, the media guidance application may instead select a second potential parameter and/or type of transaction condition at step 1010.

Even if the media guidance application determines at step 1004 that the current status of the environmental factor does not match the first status, the media guidance application may still determine whether the current status of the environmental factor matches a second status at step 1008. Alternatively, the media guidance application may determine whether the current status of the environmental factor or a different environmental factor matches a different third status. The result of the determination performed at step 1004 may thus influence what determination is performed next.

If the media guidance application determines at step 1008 that the current status of the environmental factor matches the second status, the media guidance application may select a third potential parameter and/or type of transaction condition at step 1012.

If the media guidance application determines at step 1008 that the current status of the environmental factor also does not match the second status, the media guidance application may instead select a fourth potential parameter and/or type of transaction condition at step 1014.

The selection of a potential parameter and/or type of transaction condition at any one of steps 1008-1014 may involve selecting a parameter for a transaction condition of a default type (e.g., each transaction may be subject to a rental period, but the media guidance application may use process 1000 to determine the length of the rental period), selecting a type of transaction condition that includes a default parameter (e.g., the media guidance application determines whether or not to limit access to the media asset to a maximum number of user devices, but if the media guidance application determines to include this type of transaction condition, the maximum number of user devices is set to three by default) or selecting both a parameter and a type of transaction condition (e.g., the media guidance application may select both whether to limit access to a media asset to a particular number of accesses and to what value to set this number). Additionally, a transaction may be subject to multiple transaction conditions, and selecting transaction conditions may thus involve selecting any combination of more than one parameter, type of transaction condition or both. If the transaction is subject to multiple transaction conditions, multiple potential parameters and/or types of transaction conditions may be selected at each of steps 1008-1014. Alternatively or in combination, steps 1004-1014 may be performed multiple times, potentially using different environmental factors and/or statuses, in order to select multiple potential parameters and/or types of transaction conditions.

While selecting a potential parameter and/or type of transaction condition is described as a series of nested determining steps, this need not be the case. Selecting the potential parameter and/or type of transaction condition may be performed using a look-up table (e.g., each entry corresponds to a different potential status of the environment factor and is associated with a pointer to data structures of a transaction condition to be used in each case), using a single determination (e.g., replacing a parameter in a transaction condition if a particular status of the environmental factor is present), and/or calculating a value without any determinations (e.g., the media guidance application may employ a formula to calculate a rental period based on the current temperature).

At step 1016, the media guidance application selects a transaction condition that includes the selected potential parameter and/or type of transaction condition. This may involve retrieving a data structure for the transaction condition from any one of storage 306 of FIG. 3, media content source 416 of FIG. 4 and media guidance data source 418 of FIG. 4, generating a new data structure (e.g., populating a data structure with a selected parameter and/or selected type of transaction condition), and/or modifying an existing data structure (e.g., modifying one or more fields corresponding to a parameter and/or type of transaction condition in a data structure for a default transaction condition).

At step 1018, the media guidance application generates a display of a listing for a media asset. This may involve generating a display of any one or more of listing 114, listing 116 and listing 118 of FIG. 1, advertisement 502 of FIG. 5A, advertisement 552 of FIG. 5B, advertisement 604 of FIG. 6A, advertisement 654 of FIG. 6B, display screen 700 of FIG. 7A, or any other listing associated with a media asset that is described herein.

At step 1020, the media guidance application causes an indication of the selected transaction condition to be displayed. This may involve causing any one or more of advertisement 502 of FIG. 5A, advertisement 552 of FIG. 5B, advertisement 604 of FIG. 6A, advertisement 654 of FIG. 6B and overlay 752 of FIG. 7B to be displayed. The media guidance application may display an indication of the selected transaction condition simultaneously with the listing displayed at step 1018 (e.g., advertisement 502 of FIG. 5A, advertisement 552 of FIG. 5B, advertisement 604 of FIG. 6A and advertisement 654 of FIG. 6B), before the listing is displayed (e.g., the indication of the transaction condition may be displayed after a user selection of option 702 of FIG. 7A is received but before additional user input navigating to display screen 700 of FIG. 7A is received) and/or after the listing is displayed (e.g., overlay 752 of FIG. 7B). Additionally, the media guidance application may cause the indication to be automatically displayed (e.g., the media guidance application causes overlay 752 of FIG. 7B to be displayed every time a transaction is about to be performed), or the media guidance application may cause the indication to be displayed only in response to a user request (e.g., display screen 700 of FIG. 7A may include another selectable option that reads “Click Here to View Applicable Transaction Conditions,” in which case the media guidance application may cause the indication to only be displayed in response to a user selection of this additional selectable option).

At step 1022, the media guidance application receives a user selection of the displayed listing. This may involve receiving a user selection of the displayed listing itself (e.g., receiving a user selection of advertisement 602 of FIG. 6A) and/or receiving a user selection of an option associated with the displayed listing (e.g., receiving a user selection of option 706 of FIG. 7A).

At step 1024, the media guidance application enables access to the media asset subject to the transaction conditions by performing a transaction. This enables access to the media asset under conditions defined by the parameter and/or type of transaction condition selected in one of steps 1008-1014 and included in the transaction condition in step 1016. Performing the transaction may involve generating or updating a transaction data structure and/or other steps, as discussed above in reference to FIG. 7.

The steps of process 1000 may also be performed in a variety of orders. For example, the media guidance application may first generate a display of a listing for a media asset and only in response to a user selection of the listing select a transaction condition. As another example, the media guidance application may select the transaction conditions after generating a display of a listing for a media asset but before receiving a user selection of the displayed listing.

FIG. 11 illustrates process 1100 for determining whether access to media assets obtained in previous transactions is enabled. As such, process 1100 may be performed any time (including immediately after) process 1000 is performed for a particular media asset. At step 1102, the media guidance application may receive a user selection of a media asset. This may be a user selection of one of listings 806-814 of FIG. 8, a user request for display screen 900 of FIG. 9 and/or a user selection of any media asset that was obtained in a previous transaction. Alternatively, step 1102 may involve receiving a periodic trigger, an event notification and/or a user request to access display screen 800 of FIG. 8, and receiving a selection of a media asset may involve automatically selecting the next media asset from a set or list of media assets. Any circumstances under which the media guidance application may determine the availability of a media asset, such as those described above in reference to FIG. 8, may serve as a selection of a media asset in the context of step 1102.

At step 1104, the media guidance application determines current circumstances. This may involve retrieving a current date from storage 308 of FIG. 3, receiving an identifier for the current user device from user device 300 of FIG. 3, retrieving the number of times the media asset was previously accessed from the transaction data structure, and/or a number of user devices previously authorized from the transaction data structure.

At step 1106, the media guidance application may retrieve one or more parameters and types of transaction conditions that define circumstances under which the media asset may be accessed. This may involve retrieving a final date of the rental period, a list of authorized user devices, a maximum number of authorized user devices and/or a maximum number of times a media asset may be accessed from the transaction data structure.

At step 1108, the media guidance application compares the current circumstances with the circumstances under which the media asset may be accessed to determine whether the media asset is currently accessible. This may involve determining whether user device 300 of FIG. 3 is authorized to access the media asset, whether user device 300 of FIG. 3 is of a type that is authorized to access the media asset, whether the requested manner of accessing the media asset is available, whether the current date is before the end date of a rental period, whether the media asset has been accessed using less than the maximum number of user devices and/or whether the media asset has been accessed less than the maximum number of time.

At step 1110, the media guidance application checks whether access to the media asset is enabled. If access is enabled, the media guidance application may generate a display of the media asset at step 1112. Alternatively, the media guidance may cause a listing that indicates that the corresponding media asset is available to be displayed, such as listing 806 of FIG. 8. If the media guidance application determines at step 1110 that access to the media asset is not enabled, the media guidance application may cause an indication that indicates that the media asset cannot be accessed, such as overlay 902 of FIG. 9, to be displayed at step 1114. Alternatively, the media guidance application may cause a listing that indicates that the corresponding media asset is not available to be displayed, such as listing 808 of FIG. 8.

At step 1116, the media guidance application may update the transaction data structure of the media asset. This may involve setting the flag to indicate that access to the media asset is not enabled (e.g., because the rental period has run out), adding newly authorized user devices and/or user profiles, adding a start time that indicates the first time a media asset was accessed, updating the number of authorized user devices and/or updating the number of times that the media asset was accessed.

It will be apparent to those of ordinary skill in the art that the systems and methods involved in the present application may be embodied in a computer program product that includes a computer usable, non-transitory, and/or readable medium. For example, such a computer usable medium may consist of a read-only memory device, such as a CD ROM disk or conventional ROM devices, or a random access memory, such as a hard drive device or a computer diskette, or flash memory device having a computer readable program code stored thereon.

It is understood that the various features, elements, or processes of the foregoing figures and description are interchangeable or combinable to realize or practice the implementations described herein. Those skilled in the art will appreciate that aspects of the application can be practiced by other than the described implementations, which are presented for purposes of illustration rather than of limitation, and the aspects are limited only by the claims which follow.

What is claimed is:

1. A method for selecting terms of a transaction, the method comprising:
receiving a data structure associated with an environmental factor, wherein the data structure comprises information indicating a current status of the environmental factor;
selecting, based on the current status of the environmental factor, a transaction condition, wherein the transaction condition comprises a parameter that indicates under which circumstances access to a media asset is enabled;
generating a display of a listing for the media asset;
causing an indication of the transaction condition to be displayed; and
in response to receiving a user selection of the listing, enabling access to the media asset under the circumstances indicated by the parameter of the transaction condition.

2. The method of claim 1, wherein the current status of the environmental factor comprises a current weather, and wherein receiving the data structure comprises receiving the data structure from a remote server associated with a weather service.

3. The method of claim 1, wherein the current status comprises one of a current time of day and a current day of week, and wherein receiving the first data structure comprises retrieving the first data structure from memory.

4. The method of claim 1, further comprising:
monitoring user interactions;
generating a user profile based on the monitored user interactions; and
wherein selecting the transaction condition comprises selecting the transaction condition based on the user profile.

5. The method of claim 1, further comprising:
determining if the current status of the environmental factor matches a first status;
if the current status matches the first status, selecting the parameter of the transaction condition to comprise a first length of time during which access to the media asset is enabled; and
if the current status does not match the first status, selecting the parameter of the transaction condition to comprise a second length of time during which access to the media asset is enabled, wherein the second length of time is shorter than the first length of time.

6. The method of claim 5, wherein:
the current status of the environmental factor comprises a current weather;
determining if the current status of the environmental factor matches the first status comprises determining if the current weather comprises one or more of rain, a temperature below a first threshold and a humidity above a second threshold.

7. The method of claim 5, wherein:
the current status comprises a current date; and
determining if the current status of the environmental factor matches the first status comprises determining if the current date corresponds to a workday.

8. The method of claim 1, further comprising:
determining if the current status of the environmental factor matches a first status;
if the current status matches the first status, selecting the parameter of the transaction condition to comprise a first maximum number of user devices from which the media asset can be accessed; and
if the current status does not match the first status, selecting the parameter of the transaction condition to comprise a second maximum number of user devices from which the media asset can be accessed, wherein the first maximum number is smaller than the second maximum number.

9. The method of claim 1, further comprising:
receiving a user request to access the media asset;
determining, based on the parameter of the transaction condition, if access to the media asset is enabled;
if access to the media asset is enabled, generating a display of the media asset; and
if access to the media asset is not enabled, causing an indication that access to the media asset is not enabled to be displayed.

10. The method of claim 1, further comprising:
receiving a user request to display listings for media assets for which access is enabled;
determining, based on the parameter of the transaction condition, if access to the media asset is enabled; and
if access to the media asset is enabled, generating a display of a second listing for the media asset.

11. A system for selecting terms of a transaction, the system comprising:
processing circuitry configured to:
receive a data structure associated with an environmental factor, wherein the data structure comprises information indicating a current status of the environmental factor;
select, based on the current status of the environmental factor, a transaction condition, wherein the transaction condition comprises a parameter that indicates under which circumstances access to a media asset is enabled;
generate a display of a listing for the media asset;
cause an indication of the transaction condition to be displayed; and
in response to receiving a user selection of the listing, enable access to the media asset under the circumstances indicated by the parameter of the transaction condition.

12. The system of claim 11, wherein the current status of the environmental factor comprises a current weather, and wherein the processing circuitry is configured to receive the data structure by being further configured to receive the data structure from a remote server associated with a weather service.

13. The system of claim 11, wherein the current status comprises one of a current time of day and a current day of week, and wherein the processing circuitry is configured to receive the first data structure by being further configured to retrieve the first data structure from memory.

14. The system of claim 11, wherein the processing circuitry is further configured to:
monitor user interactions;
generate a user profile based on the monitored user interactions; and
wherein the processing circuitry is configured to select the transaction condition by being further configured to select the transaction condition based on the user profile.

15. The system of claim 11, wherein the processing circuitry is further configured to:
determine if the current status of the environmental factor matches a first status;
if the current status matches the first status, select the parameter of the transaction condition to comprise a first length of time during which access to the media asset is enabled; and
if the current status does not match the first status, select the parameter of the transaction condition to comprise a second length of time during which access to the media asset is enabled, wherein the second length of time is shorter than the first length of time.

16. The system of claim 15, wherein:
the current status of the environmental factor comprises a current weather;
the processing circuitry is configured to determine if the current status of the environmental factor matches the first status by being further configured to determine if the current weather comprises one or more of rain, a temperature below a first threshold and a humidity above a second threshold.

17. The system of claim 15, wherein:
the current status comprises a current date; and
the processing circuitry is configured to determine if the current status of the environmental factor matches the first status by being configured to determine if the current date corresponds to a workday.

18. The system of claim 11, wherein the processing circuitry is further configured to:
determine if the current status of the environmental factor matches a first status;
if the current status matches the first status, select the parameter of the transaction condition to comprise a first maximum number of user devices from which the media asset can be accessed; and
if the current status does not match the first status, select the parameter of the transaction condition to comprise a second maximum number of user devices from which the media asset can be accessed, wherein the first maximum number is smaller than the second maximum number.

19. The system of claim 11, wherein the processing circuitry is further configured to:
receive a user request to access the media asset;
determine, based on the parameter of the transaction condition, if access to the media asset is enabled;
if access to the media asset is enabled, generate a display of the media asset; and
if access to the media asset is not enabled, cause an indication that access to the media asset is not enabled to be displayed.

20. The system of claim 11, wherein the processing circuitry is further configured to:
receive a user request to display listings for media assets for which access is enabled;
determine, based on the parameter of the transaction condition, if access to the media asset is enabled; and
if access to the media asset is enabled, generate a display of a second listing for the media asset.

21-40. (canceled)
